(19) United States
(12) Patent Application Publication
(10) Pub. No.: US 2026/0290210 A1
(43) Pub. Date: Sep. 24, 2026

(54) FLEXIBLE ELECTRONIC APPARATUS AND A SOUND-INTEGRATED FLEXIBLE DISPLAY APPARATUS

(71) Applicant: POSTECH RESEARCH AND BUSINESS DEVELOPMENT FOUNDATION, Pohang-si (KR)

(72) Inventors: Su Seok CHOI, Pohang-si (KR); Ji Yoon PARK, Pohang-si (KR)

(73) Assignee: POSTECH RESEARCH AND BUSINESS DEVELOPMENT FOUNDATION, Pohang-si (KR)

(21) Appl. No.: 19/575,781

(22) Filed: Mar. 23, 2026

(30) Foreign Application Priority Data
Mar. 24, 2025 (KR) 10-2025-0037491
Mar. 12, 2026 (KR) 10-2026-0044788

(51) Int. Cl. G09F 9/37; G09F 9/30; G09F 9/33; G09F 27/00

(52) U.S. Cl. CPC G09F 9/372; G09F 9/301; G09F 9/335; G09F 27/00

(57) ABSTRACT

The present disclosure relates to a flexible electronic apparatus and a sound-integrated flexible display apparatus, and provides a flexible electronic apparatus and a sound-integrated flexible display apparatus comprising: a display unit including a plurality of display elements and provided to be flexible; and an actuating layer provided on one side of the display unit and configured to deform a shape of the display unit by an applied electrical signal.

### CROSS REFERENCE TO RELATED APPLICATIONS

This application claims priority from Republic of Korea Patent Applications No. 10-2025-0037491, filed on Mar. 24, 2025 and No. 10-2026-0044788, filed on Mar. 12, 2026, the contents of which are all hereby incorporated by reference herein in their entirety.

### TECHNICAL FIELD

The present disclosure relates to a flexible electronic apparatus and a sound-integrated flexible display apparatus, and more particularly, to a flexible electronic apparatus and a sound-integrated flexible display apparatus capable of providing various user experiences.

### BACKGROUND

Recently, as the demand for organic user interfaces (OUIs) increases in the field of human-electronics interaction, flexible display technology capable of shape deformation such as folding or bending is drawing great attention as a next-generation display. In particular, in order to maximize the user experience, there is an essential need to implement a 'flexible multifunctional form factor' that integrates various elements such as speakers and sensors while maintaining the original thin and lightweight characteristics of the display.

However, conventional bendable displays have mainly used a method of applying direct force to the display panel through an additional mechanical structure such as a wire attachment or a hinge to deform the screen. Such mechanical driving devices are generally rigid and bulky, thereby degrading the flexibility of the entire device and increasing the thickness, and have limitations in performing deformation operations of various shapes beyond simple unidirectional bending. Therefore, there is an urgent need to develop a new technology capable of implementing more diverse shape deformations without relying on conventional mechanical implementations and without compromising the flexibility of the overall display.

Meanwhile, in order to improve immersibility when using a display from the user's perspective, it is desirable to provide auditory sound information as well as visual display information. Accordingly, an additional speaker unit for sound reproduction is generally required for the display apparatus. However, while such a configuration is equally required for a flexible display capable of various shape deformations, a separate speaker device used in a conventional display increases the overall thickness of the display apparatus and reduces structural flexibility, thereby limiting various shape deformation characteristics. Therefore, there is a demand for the development of a technology capable of implementing a sound function without adding a separate speaker device and without compromising the flexibility and deformation characteristics of the display itself, that is, a new sound-integrated flexible display apparatus technology capable of simultaneously implementing various shape deformations and sound functions while maintaining the structural flexibility of the display apparatus.

### SUMMARY

An object of the present disclosure is to provide a flexible electronic apparatus and a sound-integrated flexible display apparatus capable of deforming into various shapes while being thin, in order to solve the above problems. Furthermore, another object is to provide a flexible electronic apparatus and a sound-integrated flexible display apparatus capable of generating sound by vibrating simultaneously, while maintaining a thin overall thickness of the flexible display apparatus without a separate speaker device, and maintaining flexible deformability, in addition to the shape change of the display unit.

To achieve the above objects, the present disclosure provides a flexible electronic apparatus comprising: a display unit including a plurality of display elements and provided to be flexible; and an actuating layer provided on one side of the display unit and configured to deform a shape of the display unit by an applied electrical signal.

Here, the actuating layer includes an electroactive polymer (EAP), and is configured to deform the shape by generating a displacement (or strain) when an electrical signal is applied. For example, the actuating layer may be configured to include a piezoelectric polymer such as a polyvinylidene fluoride (PVDF) layer, and may also be formed of other electroactive materials.

In addition, the actuating layer is partitioned into a plurality of actuating regions, and each of the actuating regions is configured to operate by receiving a separate electrical signal. Accordingly, the actuating layer is configured to be deformable into at least one of a U-shape, an inverse U-shape, an S-shape, an inverse S-shape, and a ribbon shape.

Meanwhile, the actuating layer may be formed in a structure in which at least two layers, each of which is subjected to different strain and shape deformation by the applied electrical signal, are overlapped. Also, the at least two layers may be configured such that different electrical signals can be applied to each other.

The display unit is configured to vibrate corresponding to a frequency of the electrical signal applied to the actuating layer, and at least a portion of the applied electrical signal may have a frequency in an audible frequency range.

And, the electrical signal applied to the actuating layer by a controller may simultaneously include a first signal corresponding to the shape deformation of the display unit and a second signal corresponding to acoustic information generated through the display unit. In this case, the controller may generate an integrated signal combining the first signal and the second signal, and apply the integrated signal to the actuating layer. Alternatively, the electrical signal applied to the actuating layer may include a first signal corresponding to the shape deformation of the display unit and a second signal corresponding to acoustic information generated through the display unit.

And, the actuating layer may be controlled to selectively operate in either a first mode that deforms the shape of the display unit without generating sound through the display unit, or a second mode that generates sound through the display unit while deforming the shape of the display unit.

Meanwhile, the above object of the present disclosure can also be achieved by a sound-integrated flexible display apparatus comprising: a display layer including a plurality of display elements and provided to be flexible; and an actuating layer provided on one side of the display layer and configured to deform a shape of the display layer by an applied electrical signal.

According to the present disclosure, by utilizing an electroactive polymer layer as an actuating layer in a flexible display panel without a bulky additional driving device such as a mechanical hinge, there is an effect of inducing dynamic shape deformation without compromising the original thin thickness and flexibility. In addition, by inducing asymmetrical deformation of the actuator through precise control (strain engineering) of external electrical signals, it is possible to implement bidirectional out-of-plane bending and various and complex multi-shape transformations beyond simple unidirectional bending. Furthermore, by utilizing the characteristics of the actuator having a fast response speed, it is possible to provide multifunctionality that simultaneously achieves real-time shape deformation and sound emission of the display without a separate speaker component by using only a single integrated operating signal.

### BRIEF DESCRIPTION OF THE DRAWINGS

FIG. 1 is a view showing a flexible electronic apparatus according to an embodiment of the present disclosure.

FIGS. 2(a) and 2(b) are views showing a deformation mechanism according to a structure of a PVDF layer.

FIG. 3 is a view showing a structure of the flexible electronic apparatus of FIG. 1.

FIGS. 4(a) to 4(g) show experimental results of electromechanical characteristics of an actuating layer including an inactive layer.

FIGS. 5(a) to 5(d) and 6(a) to 6(d) are views showing multiple deformation operations of a flexible electronic apparatus having a plurality of actuating regions.

FIG. 7 is a view showing another embodiment of a flexible electronic apparatus.

FIGS. 8(a) to 8(j) shows experimental results of operational characteristics and electro-acoustic characteristics of an electronic apparatus when a structure in which a plurality of actuating layers are stacked is applied.

FIGS. 9(a) to 9(d) shows experimental results of multifunctional characteristics implemented by an electronic apparatus according to an input signal of a first example.

FIGS. 10(a) and 10(b) shows a spectrogram measurement result of sound generated from a flexible electronic apparatus.

FIGS. 11(a) to 11(d) shows experimental results of multifunctional characteristics implemented by an electronic apparatus according to an input signal of a second example.

FIG. 12 is a view showing an actuating layer of an electronic apparatus according to another embodiment.

### DETAILED DESCRIPTION

Hereinafter, a flexible electronic apparatus and a sound-integrated display apparatus according to embodiments of the present disclosure will be described in detail with reference to the accompanying drawings. In the following description, the positional relationship of each component will be described based on the drawings in principle. In addition, the drawings may be simplified or exaggerated if necessary for convenience of explanation. Therefore, the present disclosure is not limited thereto, and it goes without saying that various devices may be added, changed, or omitted.

Reference numerals are provided for convenience of explanation, and the same reference numerals may be assigned to the same components. However, even if the components are the same, different reference numerals may be assigned for convenience of explanation if they are shown in different drawings or are components of different embodiments.

Even if the configurations in the drawings are partially modified and applied, they can be regarded as equivalent configurations if they have functional similarity and identity. In addition, in light of the level of a person having ordinary skill in the art, if it is recognized as a component that should naturally be included, the description thereof may be omitted.

Meanwhile, in describing the present disclosure below, a sound-integrated display apparatus in which a sound generating function is integrated into a display apparatus will be mainly described as an example of a flexible electronic apparatus, but the present disclosure is not limited thereto. It should be noted that the present disclosure can be applied to various electronic devices in which a function of displaying visual information and a function of generating sound are integrated.

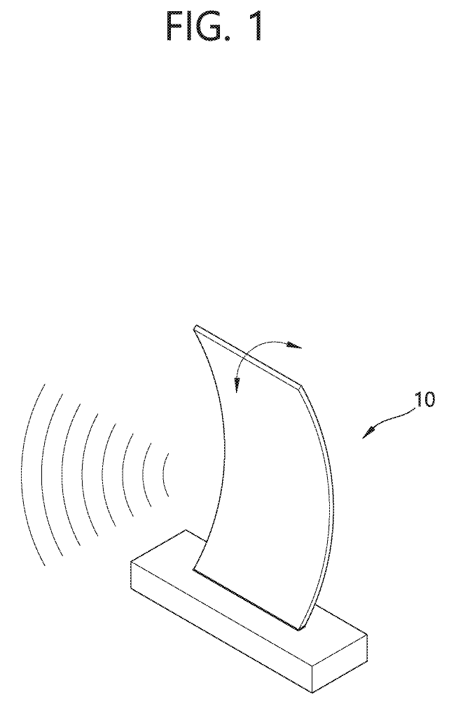

FIG. 1 is a view showing a flexible electronic apparatus according to an embodiment of the present disclosure. The flexible electronic apparatus 10 of the present embodiment may be, for example, a sound-integrated display apparatus, or a display panel-integrated sound apparatus depending on the viewpoint. The electronic apparatus 10 according to the present disclosure includes a display unit 100 having a flexible display panel, and the display unit 100 is configured to be bendable into various shapes, and may generate sound using a vibration operation of the display unit 100.

The present disclosure may use an electroactive polymer (EAP) as the actuating layer 200 for deforming the shape of the display unit. Since EAPs are lightweight, flexible, and deform in response to electrical signals, they can overcome various disadvantages of conventional deformation methods using mechanical structures such as hinges.

As an example, a piezoelectric polymer including poly(vinylidene fluoride) (PVDF), which is an electroactive polymer (EAP), is a material capable of converting electrical energy into mechanical energy by causing physical strain based on a piezoelectric-coupling effect when electrical energy is applied. Positive strain (expansion) or negative strain (contraction) can be controlled in a lateral direction depending on the polarity of the applied electric field, thereby enabling bidirectional strain switching. Moreover, electrically induced strain in a piezoelectric material such as PVDF goes beyond a simple shape change caused by a direct current (DC) or low-frequency alternating current (AC) signal, and has a very fast response speed enough to cover a response at an acoustic frequency level through the piezoelectric-coupling effect.

However, a single PVDF actuator having electrodes formed on upper and lower surfaces thereof causes a longitudinal strain deformation of contraction or expansion in an in-plane direction when an electric field is applied, but has a symmetrical strain deformation in a vertical direction. Thus, there is a structural limitation in inducing an effective deflection in an out-of-plane direction other than planar contraction or expansion deformation using only a single layer. In order to overcome the bending limitation of the single PVDF actuator, an asymmetrical strain in the vertical direction is required, and for this, a hybrid (unimorph) actuator having a heterogeneous structure may be configured by attaching an inactive layer that does not respond to an external stimulus and resists deformation to the PVDF. While the shape-maintaining characteristics of the inactive layer and the longitudinal deformation of dynamic bidirectional expansion or contraction of the PVDF by an electrical signal occur, the combined inactive layer has a fixed longitudinal deformation. Thus, when the longitudinal deformation of the active layer of the PVDF and the fixed length of the inactive layer are combined, an unbalanced and asymmetrical deformation is caused along the vertical structure of the actuator. By utilizing the principle of asymmetrical deformation of the heterogeneous layer structure, an in-plane force is converted into an out-of-plane direction, thereby achieving significantly enhanced vertical out-of-plane deflections compared to a case without an inactive layer. Furthermore, direct and rapid actuation is possible not only in a low-frequency band of less than 1 Hz but also in a high-frequency band reaching several tens of kilohertz (kHz), thereby implementing an acoustic sound function. In an actual device implementation, by applying a thin and flexible plastic OLED display panel itself as the inactive layer, a multifunctional flexible display that simultaneously performs dynamic shape deformation and sound emission without a mechanical hinge can be manufactured.

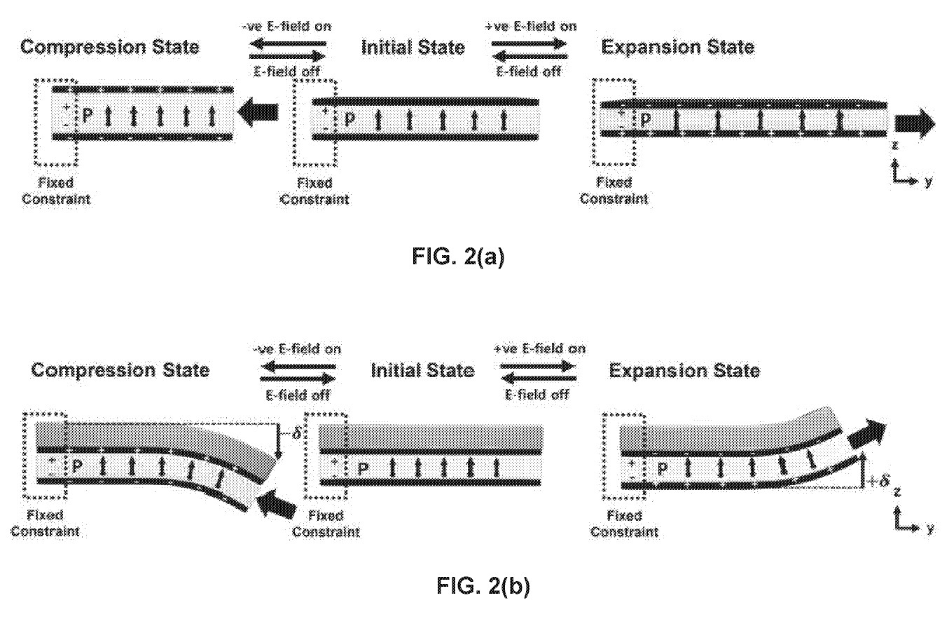

FIGS. 2(a) and 2(b) shows a deformation mechanism according to a structure of a PVDF layer. FIG. 2(a) shows a deformation mechanism of a single actuating layer without an inactive layer, and FIG. 2(b) shows a deformation mechanism of a heterogeneous layer structure including an inactive layer.

First, a single actuating layer is composed of a single PVDF layer without an inactive layer (referring to FIG. 2(a)), and may be referred to as a single PVDF actuator. The single PVDF actuator may have a specific polarization direction, for example, a +Z-axis polarization direction. In the present specification, an electric field in the same direction as the +Z-axis polarization direction is defined as a positive electric field, and an electric field in an opposite direction is defined as a negative electric field. The present disclosure can perform strain engineering by controlling the direction and magnitude of the applied electric field based on the +Z-axis polarization direction. Specifically, when an electric field is applied to coincide with the polarization direction (+Z direction), PVDF chains are elongated, so that the actuator contracts in a thickness direction and expands in an in-plane direction, causing a positive strain. Conversely, when an electric field is applied opposite to the polarization direction (-Z direction), the PVDF chains are contracted, so that the actuator expands in the thickness direction and contracts in a planar length direction, inducing a negative strain. At this time, the magnitude of the applied electric field may be precisely controlled as an important parameter in order to prevent dielectric breakdown of the PVDF actuator and simultaneously maximize deformation. However, in such a single PVDF actuator structure, symmetrical deformation occurs in a planar direction, so there is a structural limitation in inducing effective deflection and bending in an out-of-plane direction.

On the other hand, FIG. 2(b) illustrates a heterogeneous structure in which an inactive layer is attached to one surface of the single PVDF actuator undergoing positive or negative strain in the planar direction, which may be referred to as a hybrid actuator in contrast to the single actuator. When an electric field is applied in a state in which one end of the hybrid actuator is fixed, the PVDF positioned at a lower portion experiences the aforementioned positive or negative strain depending on the polarity of the electric field. At this time, the inactive layer attached to an upper portion resists the deformation, which consequently causes a significant asymmetry of deformation along the vertical structure. Due to such asymmetrical deformation, an in-plane force is converted into an out-of-plane direction, resulting in opposite out-of-plane deflections in a +Z-axis or -Z-axis direction. Furthermore, the deformation characteristics of such a PVDF hybrid actuator can be utilized in various ways depending on the frequency of the applied electrical signal.

For example, when a low-frequency electric field (e.g., less than 1 Hz) is applied, the positive or negative strain is induced, resulting in dynamic shape transformation in the +Z or -Z direction. On the other hand, when a high-frequency electric field including an audible frequency range (e.g., 20 Hz to 20 kHz) is applied, the deformation is rapidly repeated to generate vibration. Such rapid and repetitive deformation makes a thin and flexible OLED display attached to the actuator behave like a diaphragm to stimulate surrounding air, thereby directly generating sound from the display. Consequently, by controlling the frequency band of the applied signal, both shape deformation and sound generation can be achieved within a single device, and it is possible to implement a multifunctional flexible display integrating shape deformation and sound functions while maintaining the original thin and flexible form factor of the device.

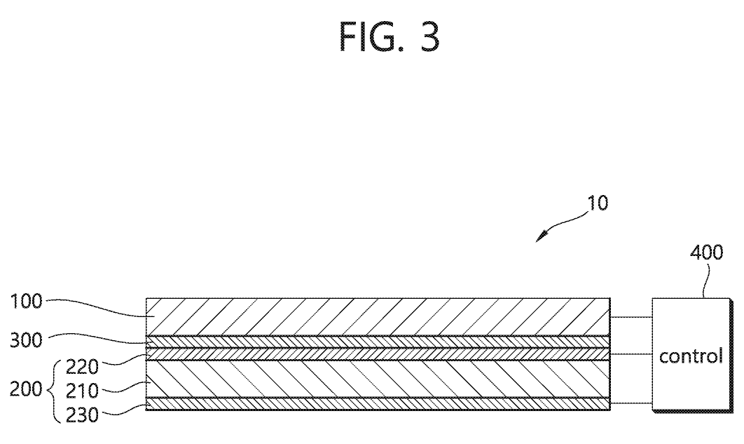

FIG. 3 is a view showing the structure of the flexible electronic apparatus of FIG. 1. As described above, the flexible electronic apparatus 10 according to the present disclosure provides a dynamic and multifunctional sound-integrated bendable display structure that simultaneously achieves shape deformation and sound generation by combining the display unit 100 forming an inactive layer and an active actuating layer 200. As shown in FIG. 3, the flexible electronic apparatus 10 according to the present embodiment is configured to include a display unit 100, an actuating unit 200, and a controller 400.

As shown in FIG. 3, the display unit 100 forms an upper layer (based on the drawing) in a plurality of layered structures constituting the electronic apparatus. The display unit 100 is a component that displays visual information to a user, and is composed of a flat display panel. A front surface of such a display panel displays visual information to the user, and a rear surface thereof is provided with an actuating layer 200 to be described later. The front surface of the display unit 100 is provided with a plurality of display elements, and is configured to display image information provided from the controller 400 through the front surface of the display unit. The display panel constituting the display unit 100 is made of a flexible material and is configured to be bendable or vibrate according to a shape deformation of the actuating layer 200 disposed on the rear surface. The display panel may use, for example, an OLED panel including a polyimide film. The thickness of the display panel may be in a range of 30 to 1000 μm, specifically, in a range of 40 to 500 μm. For example, a display panel having a thickness of about 50 μm may be used. However, this is just an example, and various display panels having a flexible structure that are bendable enough to deform in shape and can vibrate to generate sound can also be applied.

The actuating layer 200 is provided on one side of the display unit 100 and is configured to deform the shape of the display unit 100. As described above, the actuating layer 200 comprises an electroactive polymer (EAP) layer, and more specifically, a piezoelectric polymer actuator such as polyvinylidene fluoride (PVDF) having excellent piezoelectric characteristics.

As shown in FIG. 3, the actuating layer 200 includes an electroactive polymer (EAP) layer 210, and a first electrode layer 220 and a second electrode layer 230 disposed on upper and lower surfaces of the electroactive polymer layer. The electroactive polymer layer 210 is composed of a poly(vinylidene fluoride) layer, and the first electrode layer 220 and the second electrode layer 230 are configured to apply an electrical signal to the actuating layer 200 under the control of the controller 400. The thickness of the actuating layer 200 may be thinner than that of the OLED display panel constituting the display unit 100. For example, the thickness of the actuating layer 200 may be in a range of 20 to 90 μm, specifically, in a range of 30 to 50 μm, and for example, a PVDF actuator having a thickness of about 40 μm may be configured.

Meanwhile, an adhesive layer 300 is interposed between the display unit and the actuating layer. The adhesive layer 300 serves to adhere the display unit 100 and the actuating layer 200 to each other, thereby allowing the display unit 100 and the actuating layer 200 to be integrally deformed by a deformation generated on either side. For example, the adhesive layer 300 uses an optically clear adhesive (OCA) film, and the thickness of the adhesive layer 300 may be in a range of 5 to 100 μm, and for example, may be configured to have a thickness of about 20 μm.

The controller 400 is connected to the display unit 100 and the actuating layer 200 to control operations of the display unit 100 and the actuating layer 200. The controller 400 transmits image information to be displayed on the display unit 100 to the display unit, and the display unit 100 displays the provided image information. Also, the controller 400 applies an electrical signal for operating the actuating layer 200 to the actuating layer 200, and the actuating layer 200 is driven by the applied electrical signal to deform the shapes of the actuating layer 200 and the display unit 100.

A multifunctional operation mechanism of the flexible electronic apparatus 10 including the above configuration is as follows. In the flexible electronic apparatus 10 according to the present embodiment, as the controller 400 applies an electrical signal to the actuating layer (PVDF actuator) 200, physical strain is generated and deformation is caused in the actuating layer 200. At this time, the display panel forming the display unit 100 acts as an inactive layer, thereby causing various bending deformations like a hybrid actuating layer as described above. At this time, the display unit 100 is deformed into a shape corresponding to the actuating layer 200, and the controller 400 may individually or simultaneously implement a shape deformation and sound generating function within a single device by adjusting the polarity and frequency range of the electrical signal applied to the actuating layer.

Specifically, when the controller 400 applies a low-frequency signal to the actuating layer 200, the entire electronic apparatus including the display unit 100 gradually changes its shape and causes bending deformation in response to the actuating layer 200. At this time, the controller 400 may perform strain engineering that precisely induces positive strain (expansion) and negative strain (contraction) of the actuating layer 200 by individually controlling the direction and magnitude of the applied electrical signal. Through this strain-engineering method, not only simple bidirectional bending of the device but also various and complex deformations into multiple shape forms such as a 'U'-shape or an 'S'-shape can be implemented.

On the other hand, when the controller 400 applies a high-frequency signal including an audible frequency range to the actuating layer 200, positive and negative strains are rapidly and repeatedly generated alternately in the actuating layer 200 to generate vibration. The rapid vibration of the actuating layer 200 is transmitted to the display unit 100 integrally coupled through the adhesive layer, and at this time, the display panel of the display unit, which is an inactive layer, functions as a diaphragm amplifying sound without additional devices. Due to this, a sound with an enhanced sound pressure level (SPL) can be generated directly through the front surface of the display unit without adding a separate speaker exciter component.

Furthermore, the controller 400 may integrate the low-frequency bending signal for inducing the shape deformation and the high-frequency sound signal for generating the sound into a single operational signal and apply it to the actuating layer. When the integrated signal is applied in this way, the flexible electronic apparatus emits meaningful sound (e.g., a music signal) while a screen of the display unit providing image information is variously bent according to a setting.

Consequently, the flexible electronic apparatus according to the present disclosure can provide a dynamic bendable display in which shape deformation and sound output are perfectly integrated while maintaining an original thin and lightweight form factor of the display without an additional mechanical hinge or acoustic components.

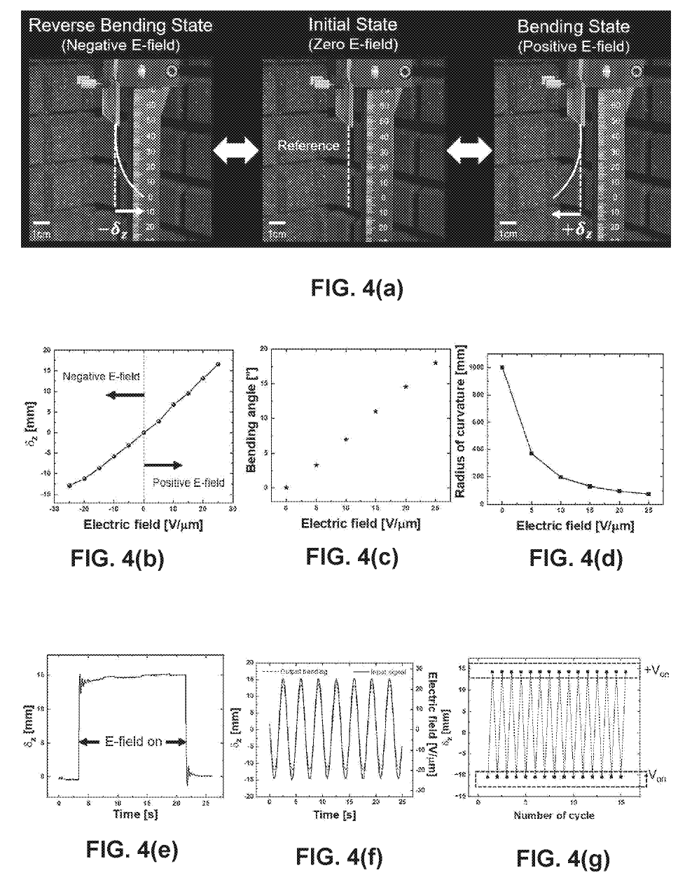

Hereinafter, the driving characteristics of the flexible display apparatus according to the present embodiment will be described in more detail with reference to FIGS. 4(a) to 4(g). FIGS. 4(a) to 4(g) shows experimental results of electromechanical characteristics of an actuating layer including an inactive layer. This experiment is performed using a model simulating a bilayer structure of the display apparatus. Specifically, a polyimide film, which is the same material as a substrate of a plastic OLED, is used as the inactive layer, and a PVDF film polarized in a specific direction is used as the actuating layer, so that they have a heterogeneously bonded structure through an optically clear adhesive (OCA) film.

Referring to FIG. 4(a), the hybrid actuator performs bidirectional bending driving in which it bends in mutually opposite directions from an initial flat state according to the direction of an applied electric field. Specifically, when a negative electric field is applied, the PVDF as the active layer undergoes negative strain, thereby deflecting the hybrid actuator to the right, and when a positive electric field is applied, the PVDF undergoes positive strain, thereby deflecting it to the left.

FIG. 4(b) is a graph showing a maximum displacement (maximum deflection, δz) in a Z-axis direction according to a magnitude of the electric field applied to the hybrid actuator. The hybrid actuator exhibits bidirectional bending having positive displacement (+δz) and negative displacement (-δz) corresponding to the positive and negative directions of the electric field, respectively, based on a state in which no electric field is applied (Zero E-field), and the maximum displacement (δz) increases linearly in proportion to the magnitude of the applied electric field.

FIGS. 4(c) and 4(d) are graphs showing a maximum bending angle and a radius of curvature of the hybrid actuator as the magnitude of the electric field increases from 0 to 25 V/μm. As shown in FIG. 4(c), the maximum bending angle increases linearly with the magnitude of the electric field like the maximum displacement (δz), reaching about 18° at 25 V/μm. On the other hand, as shown in (FIG. 4(d), the radius of curvature (R) utilized as an indicator of bending performance of the display apparatus rapidly decreases as the electric field strength increases, which means that the hybrid actuator bends with a greater curvature as the electric field increases.

FIGS. 4(c) to 4(g) show the real-time responsiveness and driving stability of the hybrid actuator to the applied electrical signal. As shown in FIG. 4(c), when a DC signal of 25 V/μm is applied, the actuator immediately responds to an external signal and stably maintains a maximum deflection state without performance degradation even as time passes while the DC signal is applied. Also, referring to FIG. 4(d), when an alternating current (AC) electric field signal of 0.3 Hz and 25 V/μm is applied, a maximum deflection output of the hybrid actuator changes in synchronization with an external input signal in real time without any delay. Furthermore, as shown in the cyclic testing result shown in FIG. 4(g), the hybrid actuator performs stable bidirectional driving without variation in bending performance even while repeating a plurality of deformation cycles (e.g., 15 cycles).

Consequently, considering that the polyimide-based inactive layer has the same mechanical properties as a plastic OLED substrate, these experimental results support that the electronic apparatus according to the present disclosure can implement stable and instantaneous bidirectional dynamic bending by utilizing a plastic OLED display panel itself as an inactive layer without an additional separate inactive layer.

Meanwhile, although the embodiment of FIG. 3 shows that the actuating layer 200 forms a single region, the actuating layer 200 may be partitioned into a plurality of actuating regions for various shape deformations of the display unit 100. Further, each actuating region may be configured to operate by independently receiving a separate electrical signal from the controller.

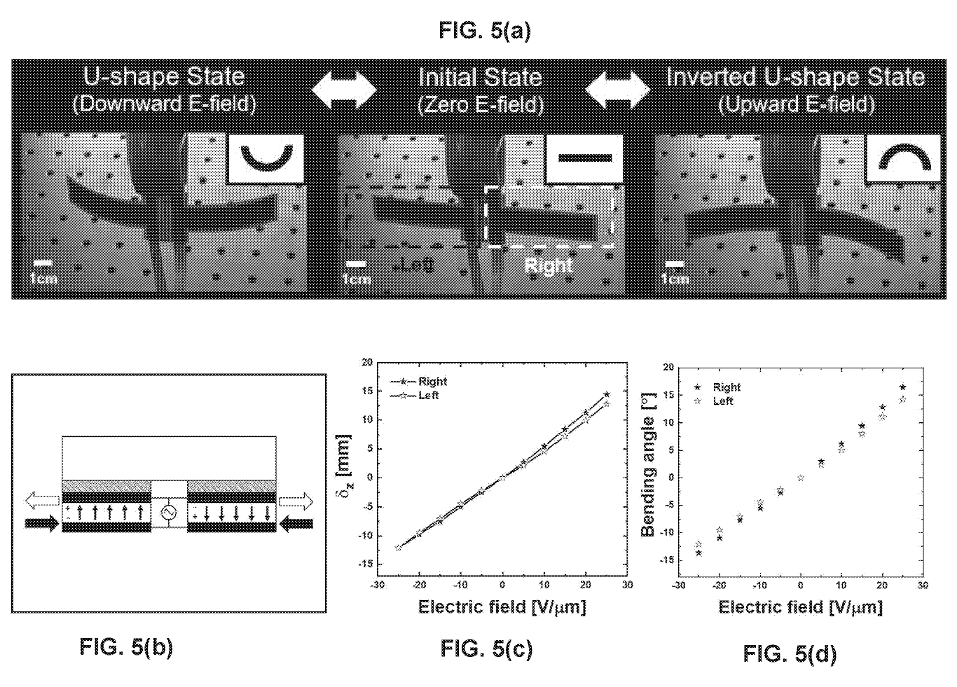

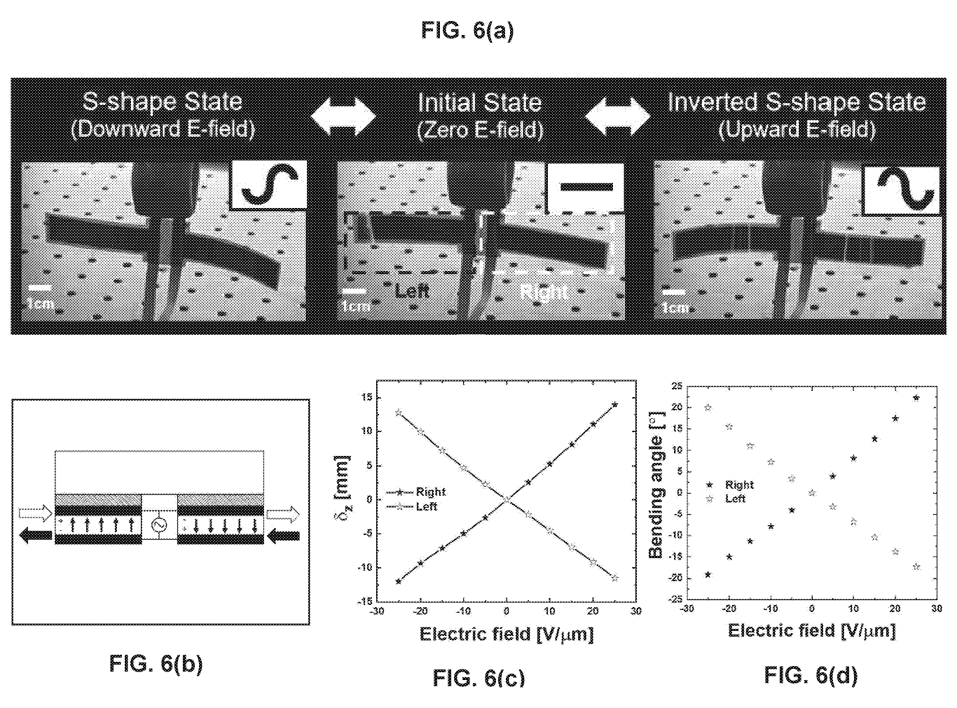

Hereinafter, operating characteristics of the electronic apparatus by an actuating layer including a plurality of actuating regions will be described with reference to FIGS. 5(a) to 5(d) and 6(a) to 6(d). FIGS. 5(a) to 5(d) and 6(a) to 6(d) are views showing multiple deformation operations of a flexible electronic apparatus having a plurality of actuating regions.

First, FIGS. 5(a) to 5(d) show an example in which the flexible electronic apparatus is deformed into a 'U-shaped' and an 'inverted U-shaped' configuration. FIG. 5(a) shows an actual driving appearance of the display apparatus deformed from a flat initial state to U-shaped and inverted U-shaped configurations as an electric field is applied to the actuating layer 200 in a downward or upward direction.

Referring to FIG. 5(b), a structure and a mechanism of the display apparatus for implementing the U-shaped and inverted U-shaped deformation are shown. As shown in FIG. 5(b), an actuating layer 200 is provided below the display unit 100 forming an inactive layer, and the actuating layer is configured to be partitioned into a pair of actuating regions. The pair of actuating regions is a configuration in which a single PVDF actuator having the same polarization direction (e.g., an upward polarization direction) is symmetrically attached to a left side and a right side of the display unit 100 via an adhesive layer (OCA film, etc.).

At this time, when an upward electric field is applied in a state in which a center of the inactive layer (display unit) 100 is fixed, positive strain (expansion) occurs in both actuating regions, so that both sides of the electronic apparatus are bent upward to form an inverted U-shaped (∩) configuration. Conversely, when a downward electric field is applied, negative strain (contraction) occurs in both PVDFs, so that both sides of the electronic apparatus are bent downward to form a U-shaped (U) configuration.

FIGS. 5(c) and 5(d) respectively show a maximum deflection (δz) and a maximum bending angle of the left side and the right side according to the magnitude of the applied electric field for the electronic apparatus transformed into U-shaped and inverted U-shaped configurations. As the magnitude of the applied electric field increases, the deflection and bending angle of both the left and right sides linearly increase. At this time, the reason why the left side and the right side cause symmetrical deformation is because the PVDF actuators having the same structure attached to both sides show the same behavior in response to the electrical signal.

Meanwhile, FIGS. 6(a) to 6(d) show an example in which the flexible electronic apparatus is deformed into an 'S-shaped' and an 'inverted S-shaped' configuration. FIG. 6(a) shows an actual driving appearance of the electronic apparatus deformed from a flat form to S-shaped and inverted S-shaped configurations when an upward or downward electric field is applied.

Referring to FIG. 6(b), a structure and mechanism of the display apparatus for implementing the S-shaped and inverted S-shaped deformation are shown. Unlike the example of FIGS. 5(a) to 5(d), in the example shown in FIG. 6(b), two single PVDF actuators 200 having different polarization directions from each other are attached below the display unit 100. For example, a PVDF having upward polarization may be disposed on the right side, and a PVDF having downward polarization may be disposed on the left side.

In this case, when an upward electric field is applied in a state in which the center of the inactive layer 100 is fixed, the PVDF on the right side experiences a positive strain (expansion), while the PVDF on the left side experiences a negative strain (contraction). Due to this difference in asymmetrical deformation, the right side bends upward and the left side bends downward, resulting in an inverted S-shaped (Ϩ) configuration. Conversely, when a downward electric field is applied, the left and right sides of the electronic apparatus perform operations opposite to the above to form an S-shaped (S) configuration.

FIGS. 6(c) and 6(d) show a maximum deflection (δz) and a maximum bending angle of the left side and the right side according to the magnitude of the applied electric field for the electronic apparatus transformed into S-shaped and inverted S-shaped configurations, respectively. As the electric field increases, the deflection and bending angle of the left and right sides change in opposite directions starting from 0 V/μm. This is because actuators having different polarization structures are disposed on both sides and react opposite to each other to the same electrical signal, thereby inducing asymmetrical bending.

As discussed above, the electronic apparatus according to the present embodiment is configured such that the actuating layer 200 includes a plurality of actuating regions, and may cause various shape deformations by variously arranging polarization directions of the electroactive polymer (PVDF) for each region. However, although FIGS. 5(a) to 5(d) and 6(a) to 6(d) disclose a structure in which the actuating layer 200 includes two actuating regions that are symmetrical to the left and right, the present disclosure is not limited thereto, and may be configured to include three or more actuating regions or to be asymmetrically arranged on the display unit 100 according to a role and a desired deformed shape. Further, although FIGS. 5(a) to 5(d) and 6(a) to 6(d) describe examples in which the same electrical signal is applied but the polarization direction of the PVDF layer is opposite, it is also possible to configure such that the same shape deformation is caused by applying opposite electrical signals even if the polarization direction of each actuating region is the same.

Consequently, by configuring the actuating layer 200 to include a plurality of actuating regions and utilizing a strain engineering approach of arranging differently or independently controlling polarization directions of the electroactive polymer (PVDF) for each region, the flexible electronic apparatus of the present disclosure can effectively achieve highly complex and various multiple shape transformations tailored to a user's needs beyond simple out-of-plane bending.

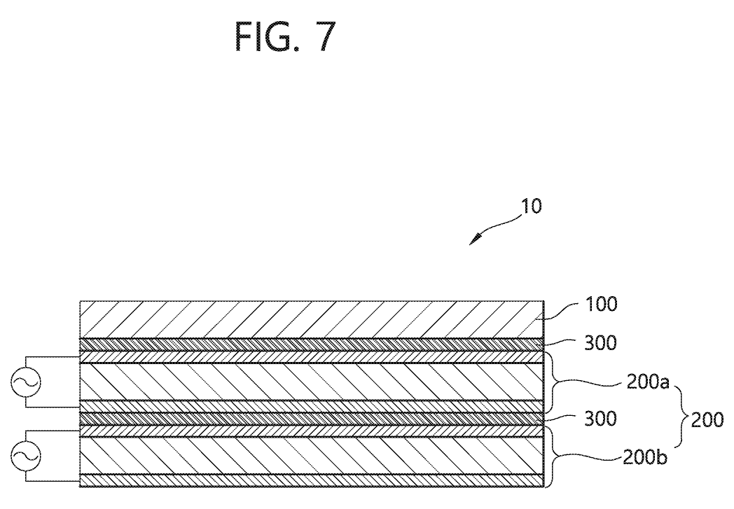

FIG. 7 is a cross-sectional view showing another embodiment of a flexible electronic apparatus. In the embodiment of FIG. 3 described above, the actuating layer is configured such that a single PVDF actuator forms a single layer, but as another embodiment, the actuating layer may be configured to form a plurality of layers.

As an example, as shown in FIG. 7, the actuating layer is configured in a structure in which a first actuating layer 200a and a second actuating layer 200b are stacked, and the first and second actuating layers 200a and 200b are each composed of a separate PVDF actuator. And, the first and second actuating layers are independently controlled by separately receiving electrical signals from the controller. When a plurality of stacked actuating layers 200 are used as in the present embodiment, not only can the electronic apparatus be deformed into a larger range of displacement, but there is also an advantage that various types of deformation are possible.

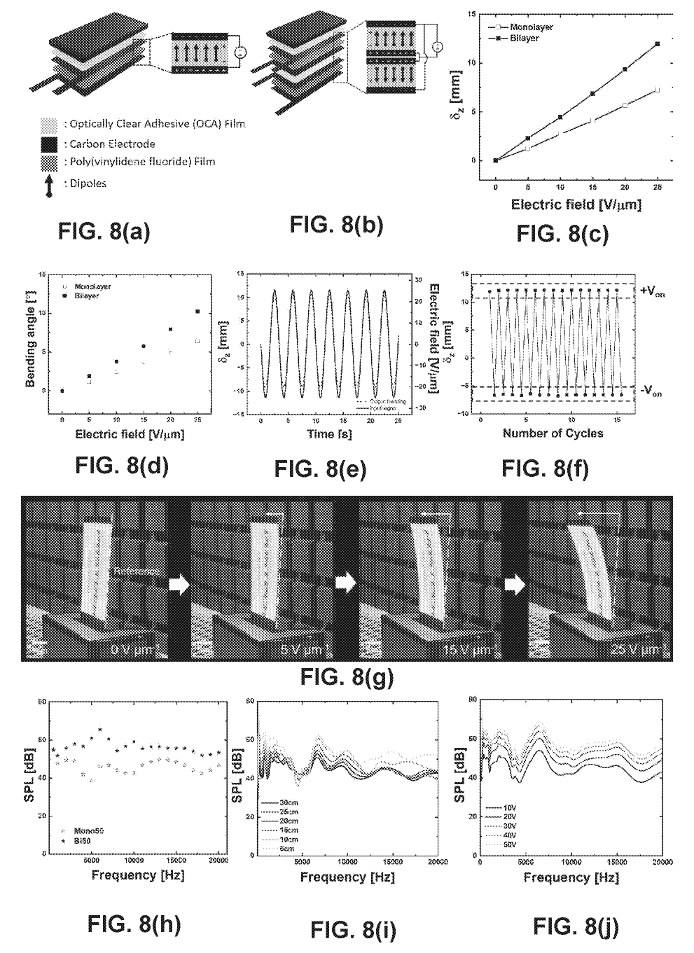

FIGS. 8(a) to 8(j) show experimental results of operational characteristics and electro-acoustic characteristics of an electronic apparatus when a structure in which a plurality of actuating layers are stacked is applied. Hereinafter, the operational characteristics and electro-acoustic characteristics of the electronic apparatus according to the stacked structure of the actuating layer will be described.

FIG. 8(a) shows the structure of a monolayer-bendable display in which the actuating layer 200 is composed of a single PVDF layer, and FIG. 8(b) is a schematic diagram showing the structure of a bilayer-bendable display in which the actuating layer 200 is configured by stacking two PVDF layers. The bi-layer structure may be manufactured, for example, by stacking two single actuators having electrodes formed thereon via an optically clear adhesive (OCA) film, and then placing a flexible display panel functioning as an inactive layer thereon. In this experiment, both structures are designed to generate a positive strain (expansion) when a positive electric field is applied.

FIGS. 8(c) and 8(d) are graphs respectively comparing the electromechanical characteristics, that is, the maximum deflection (maximum displacement, δz) and the maximum bending angle according to the magnitude of the electric field applied to the monolayer bendable electronic apparatus (FIG. 8(a)) and the bilayer bendable electronic apparatus (FIG. 8(b)). As shown in FIG. 8(c), as the magnitude of the applied electric field increases, both electronic apparatuses exhibit upward bending and their deflections increase. However, when the same electric field of 25 V/μm is applied, the maximum deflection of the bilayer bendable display is about 11.97 mm, showing a larger deformation compared to the monolayer (about 7.24 mm). Similarly, referring to (d) of FIG. 8, when 25 V/μm is applied, the maximum bending angle of the bilayer structure is about 10.24°, showing improved bending performance compared to the monolayer (about 6.4°). This is because the actuator composed of two actuating layers (PVDF layers) generates a greater force to bend a relatively thick and rigid display panel.

FIG. 8(e) to 8(g) show the real-time driving responsiveness and stability of the bilayer electronic apparatus. Referring to FIG. 8(e), when an alternating current (AC) signal of 0.3 Hz and 25 V/μm is applied, the output deflection of the bilayer bendable display is synchronized in real time without delay to changes in the input signal. In addition, as shown in the cyclic testing result of FIG. 8(f), it operates stably without degradation of bending performance even while repeating a plurality of deformation cycles. And, FIG. 8(g) shows an actual driving appearance in which the electronic apparatus bends progressively more from an initial flat position as the magnitude of the applied electric field (e.g., 0, 5, 15, 25 V/μm) increases.

FIGS. 8(h) to 8(j) are graphs for explaining differences in electro-acoustic characteristics according to the stacked structure of the actuating layer and optimal conditions for sound generation. FIG. 8(h) is a result of measuring a sound pressure level (SPL) generated by applying a signal of an audible frequency band (20 Hz to 20 kHz) and a voltage of 50 V to the monolayer and bilayer electronic apparatuses. It can be confirmed that when the same voltage is applied, the bilayer electronic apparatus generates a higher SPL across the entire audible frequency band, which means that the bilayer structure causes a larger mechanical deformation under the same signal, resulting in improved vibration and sound emission. FIGS. 8(i) and 8(j) show changes in SPL according to sound pressure measurement conditions and an applied voltage of an electronic apparatus equipped with a bilayer actuating layer. As shown in FIG. 8(i), as the distance between the display and a microphone measuring sound decreases, a higher SPL is measured, and as shown in FIG. 8(j), a higher SPL can be achieved as the driving voltage (e.g., increasing from 10 V to 50 V) applied to the bilayer electronic apparatus increases.

As such, when the actuating layer 200 is configured by stacking a plurality of layers (e.g., a bilayer), not only a greater mechanical bending deformation can be induced under the same electrical signal compared to a single-layer structure, but also the display panel serving as a diaphragm is vibrated more strongly to stably generate a sound of a higher sound pressure level (SPL) across the entire audible frequency band. This suggests that the flexible electronic apparatus 10 according to the present disclosure can be usefully utilized as a high-performance multifunctional bendable display capable of simultaneously maximizing dynamic multi-shape deformation of a screen and rich acoustic output without compromising the original flexibility of the device through optimization of the number of stacked layers of the actuating layer 200 and the applied voltage.

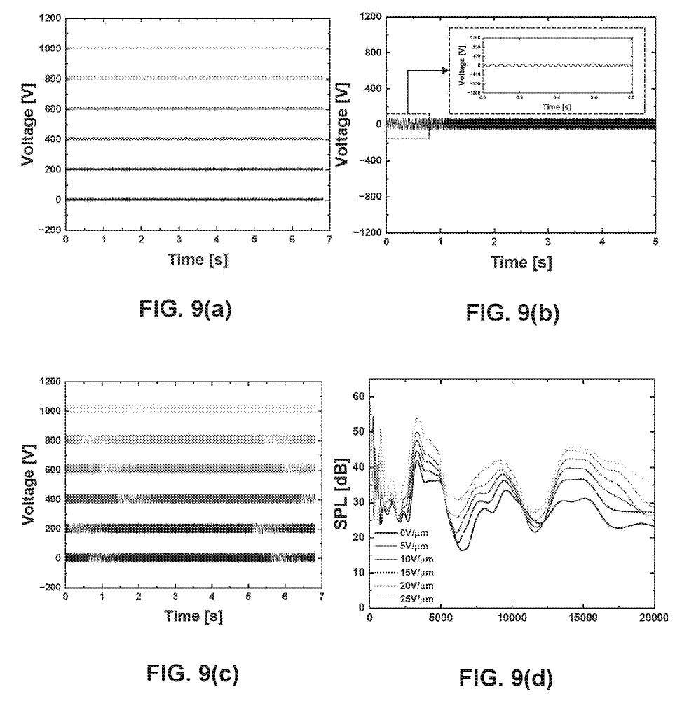

Hereinafter, multifunctional characteristics in which the flexible electronic apparatus according to the present embodiment simultaneously implements shape deformation and sound generation through a single integrated signal will be described with reference to FIGS. 9(a) to 9(d) to 11(a) to 11(d). FIGS. 9(a) to 9(d) shows experimental results of multifunctional characteristics implemented by the electronic apparatus according to an input signal of a first example. In this experiment, the experiment was performed using a bilayer bendable electronic apparatus having the stacked actuating layer 200 described in FIGS. 7 and 8(a) to 8(j), and the experiment was conducted in a manner of simultaneously applying a single signal to each actuating layer.

FIG. 9(a) shows an electrical signal value for inducing a shape deformation of the electronic apparatus, which is a direct current (DC) signal and can maintain a predetermined bending shape while the electrical signal is applied. And, FIG. 9(b) is an electrical signal value for inducing sound emission, which is an alternating current (AC) signal, and the frequency of the AC signal is an audible frequency band (for reference, when a high frequency is applied, the electronic apparatus vibrates to generate sound and a minute displacement occurs, but this vibration is considered distinct from the shape deformation affecting the user's visual information).

When the DC signal is applied to the actuating layer (e.g., the bilayer actuator described above in FIG. 7) 200, the electronic apparatus deforms its shape according to the magnitude of the signal and stably maintains the deformed state, and when the AC signal is applied, it generates a sound of a specific sound pressure level (SPL) through rapid vibration. FIG. 9(c) shows a first integrated input signal generated by combining the DC signal of FIG. 9(a) and the AC signal of FIG. 9(b). The controller 400 according to the present disclosure may electrically synthesize two signals responsible for different functions in this way to convert them into a single signal, and then apply it to the actuating layer 200. In this case, while the shape of the electronic apparatus is deformed in the same manner as when the signal of FIG. 9(a) is applied, a sound corresponding to when the signal of FIG. 9(b) is applied is generated. In this way, through the signal integration method, dynamic shape deformation and sound emission of the screen can be simultaneously achieved within a single flexible electronic apparatus without any additional driving parts or speaker devices.

FIG. 9(d) is a graph showing sound pressure level (SPL) response characteristics measured when the first integrated input signal according to FIG. 9(c) is applied to a flexible electronic apparatus in the form of a bilayer bendable display. As shown in FIG. 9(d), it can be seen that as the magnitude of the direct current (DC) signal component among the applied integrated signal increases, the sound pressure level (SPL) generated in the device also increases correspondingly. This is because as the magnitude of the DC signal increases, the electronic apparatus bends more significantly, thereby physically concentrating acoustic energy more effectively and consequently inducing a sound of a higher sound pressure level.

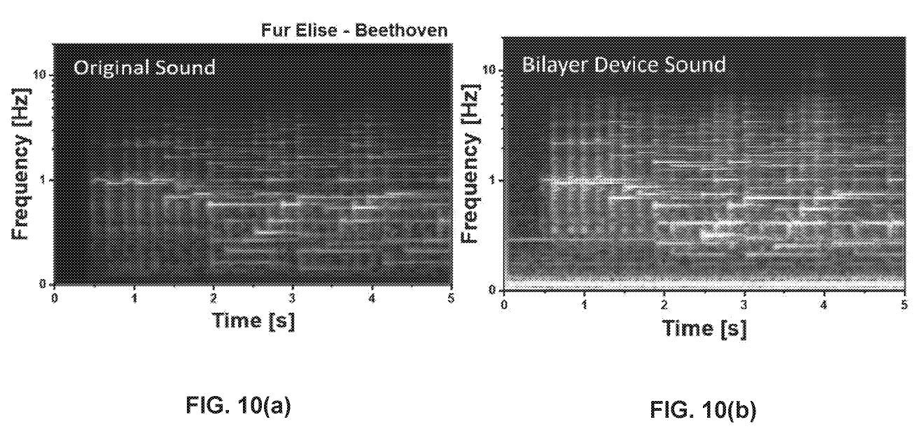

FIGS. 10(a) and 10(b) show spectrogram measurement results of sound generated from the flexible electronic apparatus. FIG. 10(a) is a spectrogram visualizing characteristics of each frequency band of an original music signal (original input) before being input to the flexible electronic apparatus, and FIG. 10(b) is a spectrogram measuring and showing sound (output sound) actually output as a diaphragm while the device maintains a bending deformation when the original music signal is combined with a shape deformation signal and applied to the flexible electronic apparatus. Comparing FIGS. 10(a) and 10(b), it can be seen that the waveform pattern of the sound finally output through the electronic apparatus appears visually very similar to the pattern of the original music signal. This proves that the flexible electronic apparatus according to the present disclosure has excellent sound output reliability capable of stably reproducing the original sound with high quality without significantly damaging or distorting the frequency characteristics of the original sound source, even in a dynamic driving environment in which physical shape deformation is continuously performed.

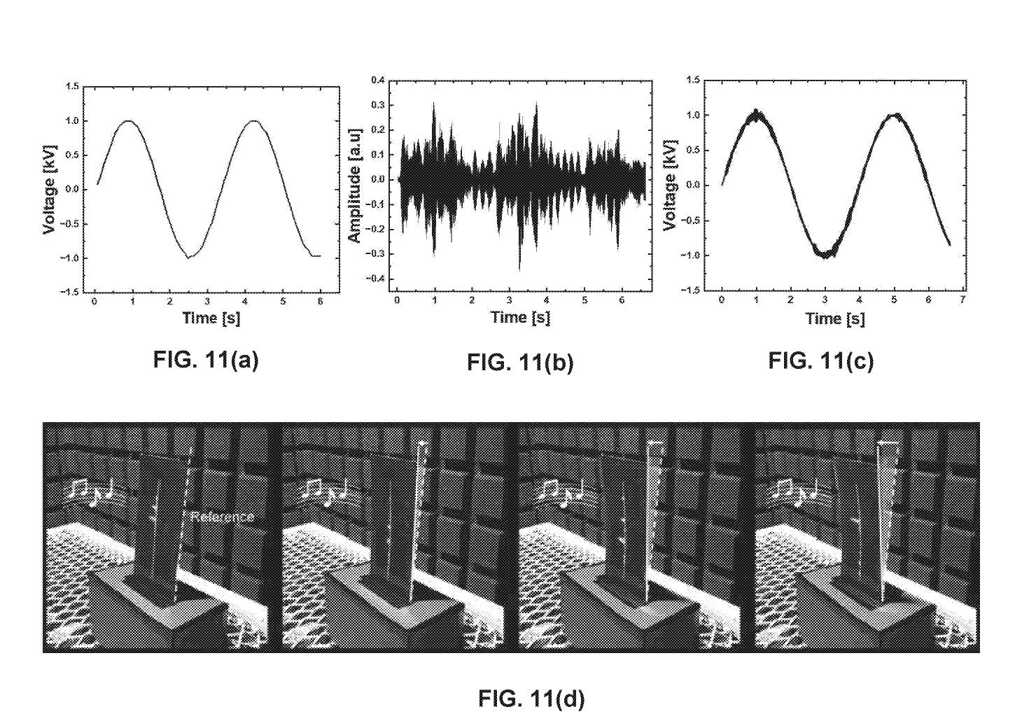

FIGS. 11(a) to 11(d) show experimental results of multifunctional characteristics implemented by the electronic apparatus according to an input signal of a second example. Similar to FIGS. 9(a) to 9(d), this experiment also used a bilayer bendable electronic apparatus having a bilayer structure actuating layer, and was conducted by simultaneously applying a single signal to each actuating layer. FIG. 11(a) is a low-frequency alternating current (AC) signal for inducing a periodic real-time shape deformation of the flexible electronic apparatus. When a low-frequency signal (e.g., 0.3 Hz and 25 V/μm) is applied from the controller 400 as shown in FIG. 11(a), the actuating layer 200 performs a dynamic movement of repeating bending deformation forward and backward according to the frequency of the corresponding signal.

And, FIG. 11(b) shows a high-frequency acoustic signal (music signal) for outputting acoustic information (in this experiment, Vivaldi's 'Four Seasons' is used). Therefore, when the acoustic signal of FIG. 11(b) is applied from the controller 400 to the actuating layer, the display unit is vibrated in a state where the actuating layer 200 is not separately deformed in shape, thereby generating a sound corresponding to the acoustic signal. FIG. 11(c) is a second integrated input signal generated by synthesizing the low-frequency AC signal shown in FIG. 11(a) and the music signal shown in FIG. 11(b) into one. The controller 400 may combine a low-frequency AC signal for inducing continuous shape change of the electronic apparatus and a music signal for high-quality sound generation into a single operating signal as in this experiment, as well as a direct current (DC) signal for maintaining a state in which the electronic apparatus is deformed and fixed into a predetermined shape (see FIGS. 9(a) to (d)), and apply it to the actuating layer (e.g., bilayer actuator).

FIG. 11(d) is an image captured from a video recording an actual driving appearance of the flexible electronic apparatus when the second integrated input signal is applied (musical notes are separately indicated in the captured images). As shown in FIG. 11(d), when the second integrated input signal is applied in a state where one end of the electronic apparatus is fixed, the electronic apparatus 10 dynamically performs a dynamic shape deformation of being bent forward and backward according to a set period in response to the low-frequency AC signal component in real time. At the same time, the apparatus stably emits the music through the display unit 100, which is an inactive layer, even during a bending operation that dynamically bends, in response to a music signal component coupled to the signal. As a result, through such an integrated signal application method, the flexible electronic apparatus 10 according to the present disclosure can simultaneously transmit visual dynamic movement (shape deformation) and auditory audio information (music) to a user with only a single device without additional driving devices or speaker parts, thereby maximizing its usability as a next-generation organic user interface (OUI).

In the above, a method of constructing a signal for shape deformation of an electronic apparatus and a signal for inducing sound generation as a single integrated signal and applying the same signal to stacked actuating layers has been described. However, the present disclosure is not limited thereto, and it is also possible to control to separately apply an electrical signal for shape deformation and an electrical signal for inducing sound generation to different actuating layers, respectively. For example, in simultaneously implementing shape change and sound generation in an electronic apparatus having two stacked actuating layers as shown in FIGS. 8(a) to 8(j), an electrical signal (e.g., FIGS. 9(a) or 11(a)) inducing shape deformation of the electronic apparatus 10 is applied to the second actuating layer 200b located relatively far from the display unit in FIGS. 8(a) to 8(j). And, an electrical signal (e.g., FIGS. 9(b) or 11(b)) for inducing sound generation is applied to the first actuating layer 200a adjacent relatively close to the display unit 100 to be advantageous in forming vibration of the display unit 100. In this way, it is also possible to implement a multifunctional operation by applying each signal individually to each actuating layer, rather than applying the integrated signals.

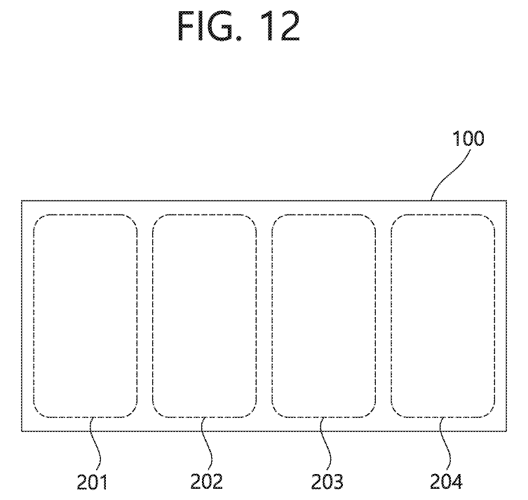

Meanwhile, FIG. 12 is a view showing an actuating layer of an electronic apparatus according to another embodiment. As described above, the actuating layer 200 may be partitioned and configured into a plurality of actuating regions 201, 202, 203, 204 forming regions different from each other in a rear region of the display unit. Previously, in FIGS. 5(a) to 5(d) and 6(a) to 6(d), the structure in which a pair of left and right actuating regions is formed was described, but as in the present embodiment, four actuating regions may be provided, and a pair of inner regions 202, 203 and a pair of outer regions 201, 204 arranged symmetrically with respect to a center may be formed. And, each of the actuating regions is independently controlled by the controller 400.

In the above, in simultaneously implementing shape deformation and sound generation of the electronic apparatus, an example in which the shape deformation signal and the sound generation signal are integrated and equally applied to each of the stacked actuating layers, or the shape deformation signal and the sound generation signal are respectively separated and applied to each stacked actuating layer has been described. However, in addition to this, the shape deformation signal and the sound generation signal may be separately applied to a plurality of actuating layers configured in different regions, as in the present embodiment. As an example, an electrical signal inducing shape deformation is applied to the inner pair of actuating regions 202 and 203 among the plurality of actuating regions in FIG. 12. This is because the inner pair of actuating regions 202 and 203 is advantageous in inducing a change in the overall shape of the electronic apparatus. And, an electrical signal for generating sound is applied to the outer pair of actuating regions 201 and 204 among the plurality of actuating regions. This is because the outer pair of actuating regions 201 and 204 is adjacent to the edge portion of the electronic apparatus maintaining an open end, which is advantageous for vibration to generate sound. In this case, among the actuating layers 200 of the electronic apparatus 10, the inner side is involved in changing the shape of the electronic apparatus, and the outer side may operate to be involved in sound generation.

On the other hand, in the case of the embodiments of FIGS. 5(a) to 5(d) and 6(a) to 6(d) described above, since the actuating regions provided in the actuating layer are provided as a left and right pair, U-shaped deformation and S-shaped deformation were possible as described above, but as the number of independently controlled actuating regions increases, the display unit can be deformed into various shapes. For example, as shown in FIG. 12, when four or more actuating regions are provided along a horizontal direction, deformation into various shapes is possible by controlling the direction and strength of an electric field formed in each actuating region. For example, when signals are applied so that electric fields in opposite directions are formed in adjacent actuating regions, the display unit may be deformed into a wave shape based on a horizontal cross section. Also, when electric fields are applied to adjacent actuating regions with the same frequency but different phases, the display unit may be deformed into a shape in which a wave waveform propagates. In addition, when the directions of the electric fields applied to a plurality of actuating regions are alternately or irregularly reversely formed, it is also possible to deform into a ribbon shape that is continuously bent in an irregular pattern. Besides, more various shape deformations may be caused by controlling the arrangement of the actuating regions and the electrical signal applied to each actuating region.

Meanwhile, as described above, the flexible electronic apparatus according to the present disclosure can change the shape of the display unit according to the operation of the actuating layer and simultaneously generate sound through the display unit without a separate speaker component. However, the flexible electronic apparatus of the present disclosure does not always perform the above two functions simultaneously, and it is also possible to implement the functions limitedly depending on a mode. For example, the flexible electronic apparatus 10 may be configured to be controlled in a plurality of modes. For example, the first mode may be a mode operating to deform the shape of the electronic apparatus without separately generating sound, and the second mode may be a mode in which the shape of the electronic apparatus is deformed simultaneously with the sound generation. At this time, the controller 400 applies an electrical signal corresponding thereto to the actuating layer 200 based on each mode, and controls to perform an operation according to a corresponding mode.

In the first mode, the controller 400 is controlled to generate an electrical signal inducing a set shape deformation and apply it to the corresponding actuating layer 200. In contrast, in the second mode, the controller 400 performs a step of generating a signal inducing shape deformation and a signal corresponding to acoustic information. And, the controller 400 performs a step of generating a single integrated signal by combining the generated two signals. Also, the controller may apply the integrated electrical signal to a corresponding actuating layer to control shape deformation and sound emission to proceed simultaneously.

Alternatively, in the second mode, the controller 400 performs a step of generating a signal inducing shape deformation and a signal corresponding to acoustic information. Then, the generated two signals are respectively applied to different actuating layers 200a and 200b or actuating regions 201 to 204. Therefore, the actuating layer or actuating region to which the electrical signal inducing shape deformation is applied operates to cause a shape deformation of the electronic apparatus, and the actuating layer or actuating region to which the electrical signal corresponding to acoustic information is applied vibrates the display unit to cause sound emission. Although not separately classified above, an additional mode for generating only sound without shape change may be further included, or an operation corresponding to the first mode may be performed by varying an applied electrical signal.

Meanwhile, in the above-described embodiments, the flexible electronic apparatus 10 has been described centering on an example operating in a state without an additional separate speaker module, but the present disclosure is not limited thereto. When the electronic apparatus is configured to include a separate speaker module, a sound generated by vibration of the display unit 100 may operate to form a separate channel together with the separate speaker, or may be utilized as a function of performing a role different from the separate speaker (e.g., a notification independent of display information displayed on the display unit).

As described above, the flexible electronic apparatus and the sound-integrated flexible display apparatus according to embodiments of the present disclosure implement an advanced multifunctional display that provides dynamic shape deformation and sound functions simultaneously by utilizing an asymmetric deformation principle of a hybrid actuator, while maintaining the original thin, light, and flexible characteristics of the device. The present disclosure can efficiently convert an in-plane deformation generated in an actuator into a significantly enhanced out-of-plane bending by combining an electroactive polymer (PVDF) layer, which is an active layer, and a practical flexible display panel, which is an inactive layer. In particular, through positive or negative strain engineering that controls polarization of the active layer and a direction of an applied electric field, bidirectional bending and complex multiform deformations can be achieved only by controlling electrical signals without a separate mechanical hinge. Furthermore, by stacking the actuating layer into a dual PVDF layers structure rather than limiting it to a single-layer structure, bending performance and mechanical driving force can be further maximized.

In addition, the present disclosure utilizes a fast piezoelectric actuation characteristic of an electroactive polymer (PVDF) to allow a flexible OLED display panel itself to function as a diaphragm, thereby emitting a sound with an excellent sound pressure level (SPL) in an audible frequency band without adding a separate speaker. As a result, by integrally applying a low-frequency bending signal inducing a shape deformation and a high-frequency music signal as a single signal, a multisensory and multifunctional bendable display that simultaneously conveys visual dynamic shape deformation and auditory audio information to a user through a single device is realized.

In conclusion, the dynamic bendable display technology according to the present disclosure can be widely applied to various electronic devices as an organic user interface (OUI) that improves human-electronics interaction, and suggests an innovative application possibility in the development of next-generation multisensory displays, multifunctional devices, and flexible electronics industries.

While the present disclosure has been described with reference to some embodiments, the present disclosure is not limited to the above-described embodiments. It will be understood by those of ordinary skill in the art to which the present disclosure belongs that the present disclosure may be embodied in variously modified or changed forms without departing from the scope of the technical features of the present disclosure defined in the appended claims.

What is claimed is:

1. A flexible electronic apparatus comprising:
a display unit comprising a plurality of display elements and provided to be flexible; and
an actuating layer provided on one side of the display unit and configured to deform a shape of the display unit by an applied electrical signal.

2. The flexible electronic apparatus of claim 1, wherein the flexible electronic apparatus comprises heterogeneous layers comprising the actuating layer and an inactive layer that does not deform by itself.

3. The flexible electronic apparatus of claim 1, wherein the actuating layer comprises an electroactive polymer (EAP), and is configured to deform the shape by generating a physical strain when the electrical signal is applied.

4. The flexible electronic apparatus of claim 1, wherein the actuating layer comprises a piezoelectric polymer layer.

5. The flexible electronic apparatus of claim 1, wherein the actuating layer comprises a poly(vinylidene fluoride) (PVDF) layer.

6. The flexible electronic apparatus of claim 1, wherein the actuating layer comprises a plurality of actuating regions, and each of the actuating regions operates by receiving a respective electrical signal.

7. The flexible electronic apparatus of claim 1, wherein the actuating layer is configured to be deformable into at least one of a U-shape, an inverse U-shape, an S-shape, an inverse S-shape, and a ribbon-shape.

8. The flexible electronic apparatus of claim 1, wherein the actuating layer comprises at least two overlapping layers, each of which is deformed in shape by the applied electrical signal.

9. The flexible electronic apparatus of claim 8, wherein the at least two overlapping layers are configured such that different electrical signals can be applied to each other.

10. The flexible electronic apparatus of claim 1, wherein the display unit is configured to vibrate corresponding to a frequency of the electrical signal applied to the actuating layer, and at least a portion of the applied electrical signal includes a signal having a frequency in an audible frequency range.

11. The flexible electronic apparatus of claim 1, wherein the electrical signal applied to the actuating layer by a controller comprises a first signal corresponding to the shape deformation of the display unit and a second signal corresponding to acoustic information generated by the display unit.

12. The flexible electronic apparatus of claim 11, wherein the controller generates an integrated signal combining the first signal and the second signal, and applies the integrated signal to the actuating layer.

13. The flexible electronic apparatus of claim 1, wherein the electrical signal applied to the actuating layer comprises a first signal corresponding to the shape deformation of the display unit and a second signal corresponding to acoustic information generated by the display unit.

14. The flexible electronic apparatus of claim 1, wherein the actuating layer operates selectively in one of a first mode that deforms the shape of the display unit without generating sound by the display unit, and a second mode that generates sound by the display unit while deforming the shape of the display unit.

15. A sound-integrated flexible display apparatus comprising:
a display unit comprising a plurality of display elements and provided to be flexible; and
an actuating layer provided on one side of the display unit and configured to deform a shape of the display unit by an applied electrical signal.
